(19) United States
(12) Patent Application Publication
(10) Pub. No.: US 2013/0295531 A1
(43) Pub. Date: Nov. 7, 2013

(54) METHOD FOR MEAL OPTIMIZATION

(71) Applicant: ZLAVOR INC., West Sacramento, CA (US)

(72) Inventors: Giridhar Addanki, West Sacramento, CA (US); Ozer Elbeyli, Hockessin, DE (US); Corey Sayers, Bear, DE (US); Madhu Govindaraju, Vestal, NY (US)

(73) Assignee: Zlavor Inc., West Sacramento, CA (US)

(21) Appl. No.: 13/873,180

(22) Filed: Apr. 29, 2013

Related U.S. Application Data
(60) Provisional application No. 61/640,833, filed on May 1, 2012.
(60) Provisional application No. 61/813,616, filed on Apr. 18, 2013.

(51) Int. Cl. G09B 19/00

(52) U.S. Cl. CPC G09B 19/0092
USPC 434/127

(57) ABSTRACT

Disclosed is a method for meal optimization comprising of populating a database with data where the data include recipes, diet choices, menus, food items or nutritional information. A first set of inputs is received where the first set of inputs are received from a device. The first set of inputs is associated with the data. A weight value is assigned to the data then the data is ranked. An optimization algorithm engine is run based on the data and first set of inputs. A first meal plan is generated and displayed. A second set of inputs after the displaying is received where the second set of inputs are based on the first meal plan. A second meal plan is generated and displayed. Confirmation of acceptance is received and after receiving this, the second meal plan is saved in a memory. The method is performed by a software program.

### CROSS REFERENCE TO RELATED APPLICATIONS

This patent application claims priority from U.S. Provisional Patent Application No. 61/640,833 filed on May 1, 2012, and U.S. Provisional Patent Application No. 61/813616 filed on Apr. 18, 2013, both of which are incorporated herein by reference.

### BACKGROUND

Eating healthy, well-balanced-meals on a consistent basis could prevent various diet related health problems such as obesity, cardiovascular disease, hypertension, type 2 diabetes, osteoporosis, types of cancer or the like. Obtaining healthy, well-balanced-meals on our plates by either cooking at home or eating out on a daily basis and several times a day, is not only time consuming but also complicated. For example, in order to cook at home, one has to plan, buy groceries, prepare and cook. If eating out, one must go to a restaurant, decide what is ‘right’ to eat and order.

Many tools exist to aid a user in obtaining or creating healthy, well-balanced-meals including diet plans, recipes, nutrition information on food packaging, calorie information posted by restaurants, and recommendations by various experts such as the USDA (United States Department of Agriculture). The USDA Food Plate recommends eating the right proportion of vegetables, fruits, proteins, grains and dairy. This is a very complicated equation since it is a function of user needs and preferences, number of calories, proportion of macro nutrients and sources.

The user's needs and preferences are based on Body Mass Index (BMI), allergies, likes, dislikes and diets programs, while the number of calories is based on BMI which considers the user's height, weight, age, gender and level of activity. The proportion of macro nutrients is composed of proteins, fats and carbohydrates. Proteins, fats and carbohydrates are made up of a proportion of vegetables, fruits, protein, grains and dairy which in turn is a function of where the ingredients are coming from such as local or organic sources, which brand and cost.

### SUMMARY

Disclosed herein is a method for meal optimization comprising of populating a database with data where the data in the database include recipes, diet choices, menus, food items or nutritional information. A first set of inputs from a user is received where the first set of inputs are received from a device used by the user. The first set of inputs is associated with the data in the database. A weight value is assigned to the data based on the first set of inputs then the data is ranked by the weight value. An optimization algorithm engine is run based on the data and first set of inputs. A first meal plan is generated and displayed to the user on a device. A second set of inputs from the user after the displaying is received where the second set of inputs are based on the first meal plan. A second meal plan is generated and displayed to the user on a device. Confirmation of acceptance from the user is received and after receiving the confirmation from the user, the second meal plan is saved in a memory. The method is performed by a software program.

The present invention is better understood upon consideration of the detailed description below in conjunction with the accompanying drawings and claims.

### BRIEF DESCRIPTION OF DRAWINGS

FIG. 1 shows an example environment diagrammatic overview of the Meal Optimization Open Business Platform (MOOBP);

FIG. 2 shows an example flowchart for the method;

FIG. 3 shows an example flowchart for a method of Customer interaction;

FIG. 4 depicts an example of a Customer questionnaire;

FIG. 5 is an example embodiment of the Customer dashboard;

FIG. 6 details an example flowchart for a meal plan procedure;

FIG. 7 illustrates an example flowchart for a meal plan decision process;

FIG. 8 is an example embodiment of the meal plan;

FIG. 9 shows an example embodiment of the grocery list;

FIG. 10 illustrates an example flowchart for a recipe publication procedure;

FIG. 11 depicts an example flowchart for a diet publication procedure;

FIG. 12 is an example flowchart for publisher interaction;

FIG. 13 shows an example flowchart for grocery provider interaction;

FIG. 14 illustrates an example flowchart for prepared food provider interaction;

FIG. 15 shows an example flowchart for the service provider or information user interaction; and

FIG. 16 is an example flowchart for data provider interaction.

### DETAILED DESCRIPTION

The present invention provides a combination of hardware, software and network based architecture and is referred to as the Meal Optimization Open Business Platform (MOOBP). MOOBP uses interfaces, databases and algorithms to gather, store, manage and process the complex, ever growing and dynamic information about food, nutrition and user preferences such as tastes, allergies, likes, dislikes, health issues and/or the like.

This helps busy families save time and eat healthier thus improving health. Time is saved, for example, by using easy to use tools, providing intelligent grocery lists and offering less time consuming recipes with fewer ingredients. Furthermore, health is improved by eating personalized, balanced meal plans, following a plan where the user consistently eats well, having good quality ingredients and offering healthy, high quality recipes. The current invention may be used, for example, for cooking at home, for business providers such as schools, hospitals or restaurants, eating out or acquiring take-out.

Disclosed herein is a method for meal optimization comprising of populating a database with data where the data in the database include recipes, diet choices, menus, food items or nutritional information. A first set of inputs from a user is received where the first set of inputs are received from a device used by the user. The first set of inputs is associated with the data in the database. A weight value is assigned to the data based on the first set of inputs then the data is ranked by the weight value. An optimization algorithm engine is run based on the data and first set of inputs. A first meal plan is generated and displayed to the user on a device. A second set of inputs from the user after the displaying is received where the second set of inputs are based on the first meal plan. A second meal plan is generated and displayed to the user on a device. Confirmation of acceptance from the user is received and after receiving the confirmation from the user, the second meal plan is saved in a memory. The method is performed by a software program.

In another embodiment, a machine-readable medium includes instructions executable by the machine for meal optimization. The instructions cause the machine to populate a database with data where the data in the database include recipes, diet choices, menus, food items or nutritional information. A first set of inputs from a user is received where the first set of inputs are received from a device used by the user. The first set of inputs are associated with the data in the database. A weight value is assigned to the data based on the first set of inputs then the data is ranked by the weight value. An optimization algorithm engine is run based on the data and first set of inputs. A first meal plan is generated and displayed to the user on the device. Confirmation of acceptance from the user is received. After receiving the confirmation from the user, the first meal plan is optionally saved in a memory. The machine-readable medium is performed by a software program.

The machine-readable medium further comprises receiving a second set of inputs from the user after the displaying where the second set of inputs are based on the first meal plan. A second meal plan is generated and displayed to the user on the device.

The user includes a customer, publisher, grocery provider, prepared food provider, service provider, information user and data provider. The device is a computer, laptop, tablet or smartphone.

In one embodiment, before displaying the first meal plan, the first meal plan is optionally saved in the memory. The first set of inputs includes a time period for when the meal plan will be utilized by the user. In one embodiment, the time period for the meal plan is one week. In various other embodiments, the first set of inputs includes a recipe from the user. The first set of inputs includes a designation of a favorite food from the user, where the favorite food is assigned a high weight value. The first set of inputs includes a designation of a disliked food from the user, where the disliked food is assigned a low weight value. The first set of inputs includes the option to exclude food items. In another embodiment, the method further comprises a platform for communication, ordering and payment for the user.

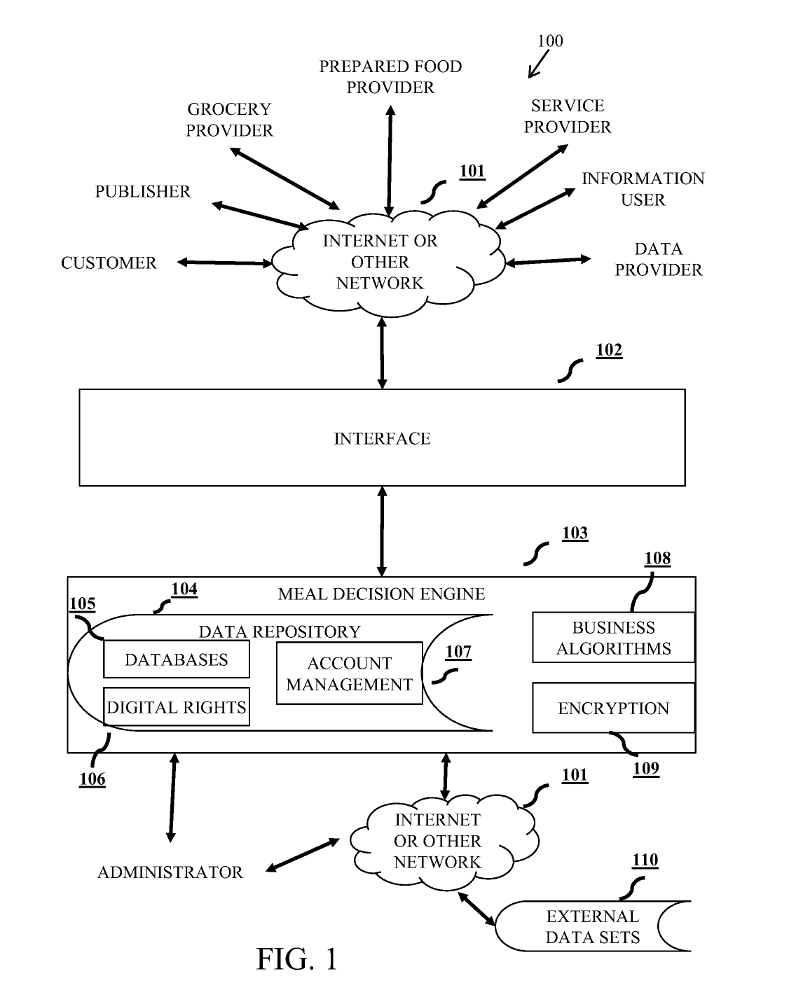

FIG. 1 shows an example environment diagrammatic overview of the Meal Optimization Open Business Platform of MOOBP. In one embodiment, MOOBP 100 supports seven example groups on one, single platform. These seven groups, for purposes hereof called “Users”, include Customer, Publisher, Grocery Provider, Prepared Food Provider, Service Provider, Information User and Data Provides.

For purposes hereof, “Customer” may include individuals or families or other groups of individuals. MOOBP 100 provides the Customer with automated and customized meal planning and grocery shopping tools. “Publisher” may include entities or individuals that author, publish, distribute or retail recipes, cookbooks, diets and other content related to food and nutrition. MOOBP 100 allows Publisher the ability to manage, distribute and retail content.

For purposes hereof, “Grocery Provider” may include entities or individuals such as Grocery Provider, farmers, food processors and other providers that grow, package, distribute or retail food products. MOOBP 100 allows Grocery Provider the ability to meet the Customer food needs. “Prepared Food Provider” may include entities or individuals such as restaurants, delis, Grocery Providers, caterers, schools, hospitals, foodservice management companies and other establishments that prepare, distribute and retail prepared food. MOOBP 100 allows Prepared Food Provider the ability to meet the food needs of the Customer.

For purposes hereof, “Service Provider” may include entities or individuals such as private chefs, nutritionists, physicians and businesses that provide advice or other services. MOOBP 100 allows Service Provider the ability to meet the Customer service needs. “Information User” may include entities or individuals such as schools, employers, insurance companies, universities and other governmental and non-governmental organizations that use information about food and exercise. MOOBP 100 allows Information User to access information about the Customer as well as other information. This aids the Information User to make better decisions while providing better products and services to the Customer.

For purposes hereof, “Data Provider” may include entities or individuals such as USDA (United States Department of Agriculture), FDA (Food and Drug Administration), universities, health clubs, pharmaceutical companies and other governmental and non-governmental organizations that provide information about the Customer food, consumption, exercise, habits, preferences, behaviors, allergies, biology, genes or the like. MOOBP 100 allows Data Provider the infrastructure to share data.

The meal decision engine 103 gathers, stores and manages data using the data repository 104, processes data using the business algorithm 108 and manages data security using the encryption 109. Data repository 104 performs the general functions of the databases 105 storing data in a memory of several structured and logical tables, the digital rights 106 using a series of rules to manage access to information by Users, and the account management 107 managing account and billing functions of the Users.

Users interact and conduct business with MOOPB 100 via a software program by accessing the interface 102 that is customized to the needs of User via the network 101. Network 101 may be the Internet or any other network.

An Administrator may access meal decision engine 103 with or without network 101 to manage administrative functions of MOOBP 100. MOOBP utilizes business algorithm 108 to access internal data stored in databases 105 and the external databases 110. The internal data is a database with data which is populated, where the data in the database include recipes, diet choices, menus, food items or nutritional information. External data 110 is accessed via network 101.

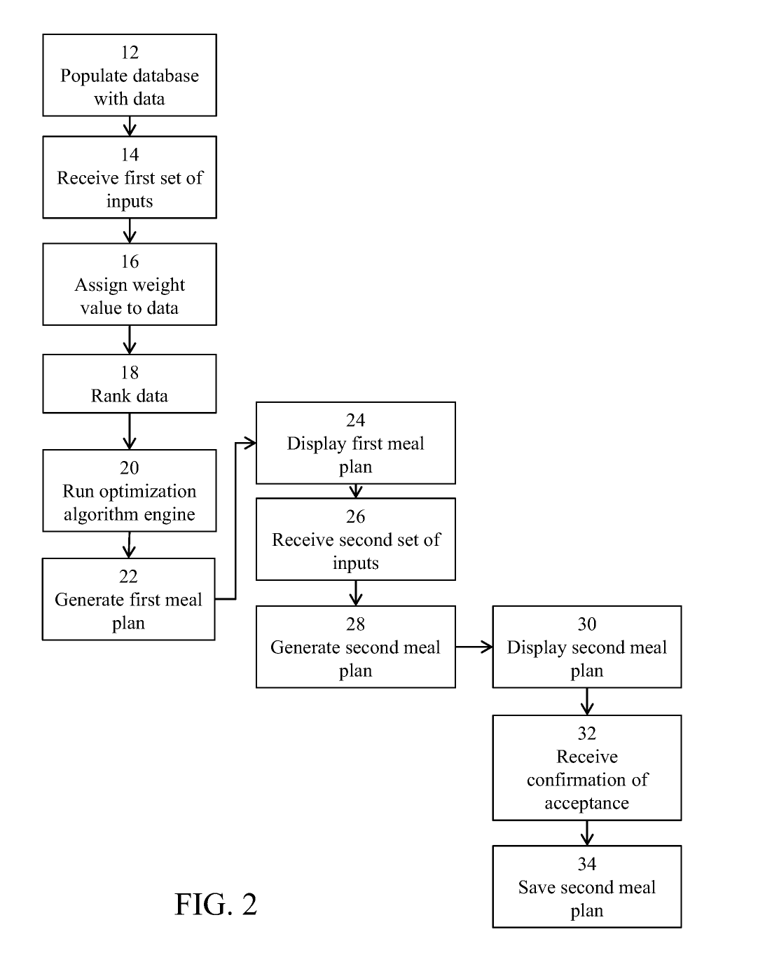

FIG. 2 shows an example flowchart for the method which is performed by a software program. At step 12, a database is populated with data where the data in the database include recipes, diet choices, menus, food items or nutritional information. In one embodiment, this is accomplished by querying the user. At step 14, a first set of inputs from a user is received where the first set of inputs are received from a device used by the user. The first set of inputs is associated with the data in the database. At step 16, a weight value is assigned to the data based on the first set of inputs, then at step 18, the data is ranked by the weight value. An optimization algorithm engine is run based on the data and first set of inputs at step 20. At step 22, a first meal plan is generated and optionally saved in the memory, and at step 24, displayed to the user on a device. The user may review the first meal plan and edit if necessary. At step 26, a second set of inputs from the user after the displaying is received where the second set of inputs are based on the first meal plan. At step 28, a second meal plan is generated and at step 30, displayed to the user on a device. The user may review the second meal plan. Confirmation of acceptance from the user is received at step 32 and after receiving the confirmation from the user, at step 34, the second meal plan is saved in a memory.

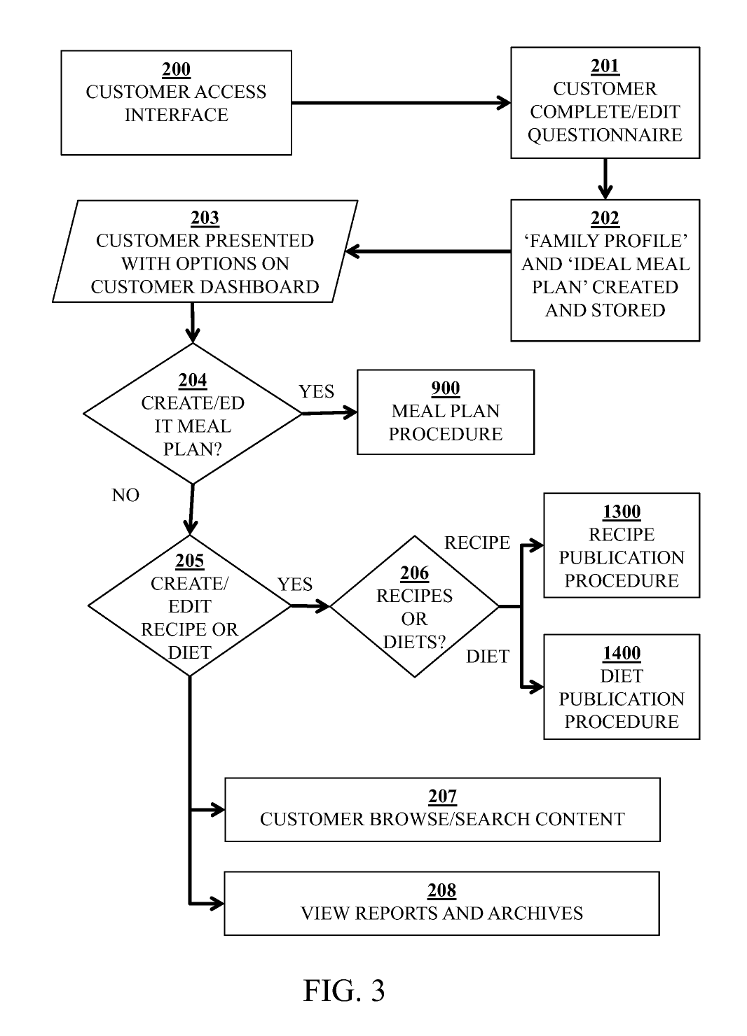

FIG. 3 shows an example flowchart for a method of the Customer interaction for the Customer to interact with MOOBP 100. In step 200, the Customer accesses MOOBP 100 using interface 102. In step 201, the Customer completes or edits questionnaire. A first set of inputs from a user or Customer are received where the first set of inputs are received from a device used by the user. The device may be a computer, laptop, tablet or smartphone. The first set of inputs is associated with the data in the database. The databases may be databases 105 or external databases 110 shown in FIG. 1.

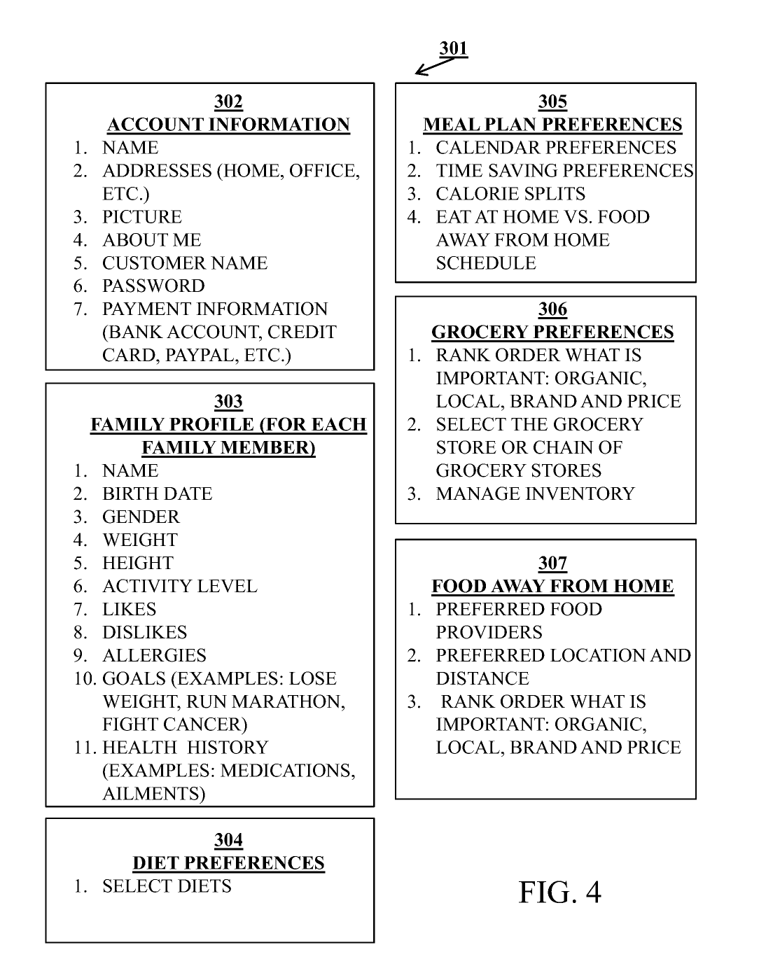

FIG. 4 depicts an example of a customer questionnaire 301. It contains questions allowing the Customer to input data about the account information 302, family profile 303, diet preferences 304, meal plan preferences 305, grocery preferences 306 and food away from home preferences 307. The first set of inputs from the user may include the option to exclude food items. The responses to these questions are stored in account management 107 of data repository 104 shown in FIG. 1.

As shown in FIG. 3 and referring to FIG. 1, after the system ensures that the customer questionnaire 301 is completed, in step 202, business algorithm 108 creates ‘Family Profile’ and ‘Ideal Meal Plan’ and stores these in account management 107. The Family Profile may include additional computations using the data in the customer questionnaire 301 and databases 105 performed by business algorithm 108. An example of these computations includes calculating the ‘Recommended Daily Caloric Intake’ of each family member and aggregating the ‘Recommended Daily Caloric Intakes’ of all family members to arrive at ‘Recommended Family Daily Caloric Intake’. Another example of these computations includes allocating the ‘Recommended Daily Caloric Intake’ to caloric intake for each course. For the purposes hereof, “Course” may include Breakfast, Lunch, Dinner and Snack courses. Consequently, ‘Recommended Daily Caloric Intake’ would be further split into ‘Recommended Daily Caloric Intake for Breakfast’, ‘Recommended Daily Caloric Intake for Lunch’, and so on. In one embodiment, the ‘Ideal Meal Plan’ is one possible meal plan for the family of the Customer. As an example, the ‘Ideal Meal Plan’ may include a set amount of calories and a set amount of micro and macro nutrients for the family of the Customer, after considering the needs and preferences of the family as established in the Family Profile.

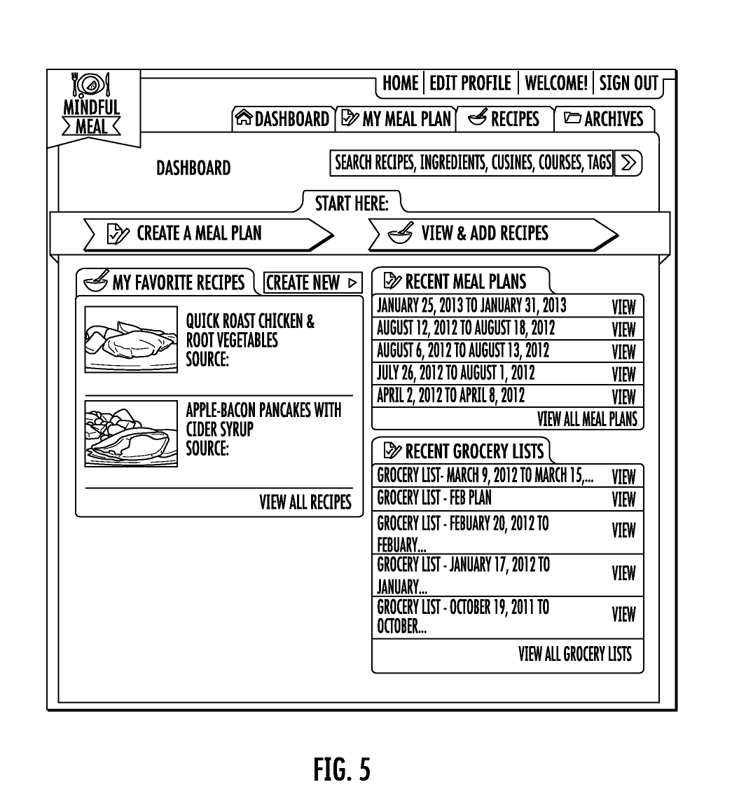

Referring to FIG. 3, in step 203, the Customer is presented with a dashboard that includes four options: Create/Edit Meal Plan 204, Create/Edit Recipe or Diet 205, Browse/Search content 207 and View Reports and Archives 208. FIG. 5 is an example embodiment of the Customer dashboard. This enables the Customer or user to enter a first set of inputs associated with the data in the database. For example, the first set of inputs may include a recipe from the user such as in Create/Edit Recipe or Diet 205.

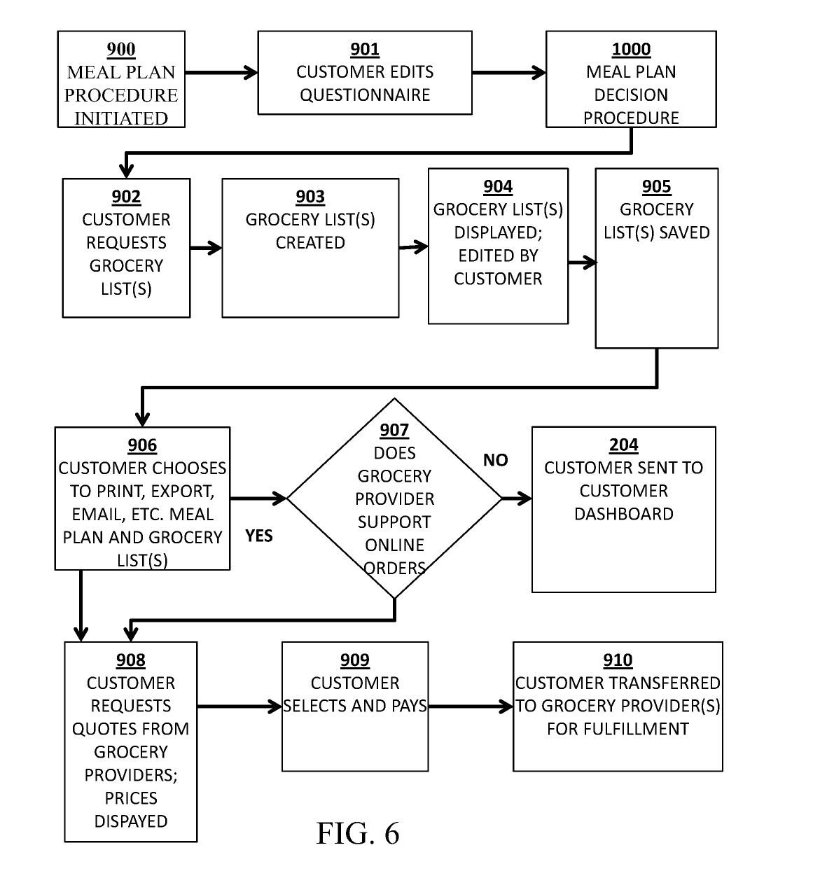

Referring again to FIG. 3, in step 204, the Customer may choose to create a meal plan. If so, then the meal plan procedure 900 is initiated. FIG. 6 details an example flowchart for a meal plan procedure to create meal plans and grocery lists. After the meal plan procedure 900 is initiated, in step 901, the Customer may edit customer questionnaire 301. In step 1000, the meal plan decision procedure starts.

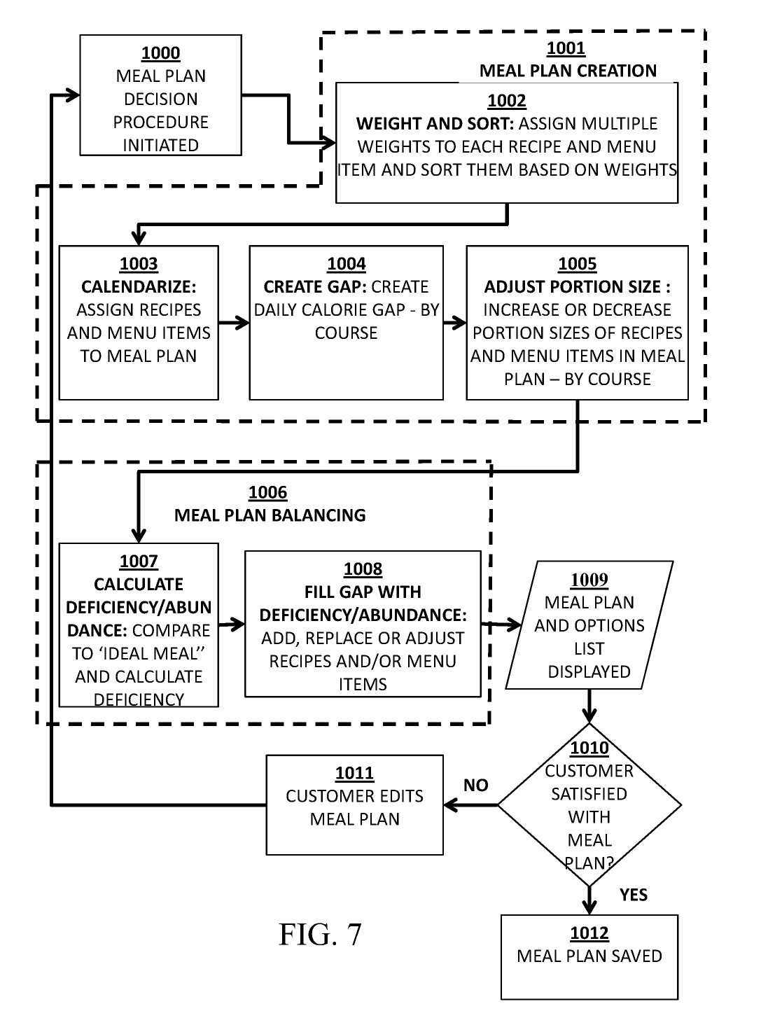

FIG. 7 illustrates an example flowchart for a meal plan decision process. Business algorithm 108 uses the information in the family profile of the Customer from step 202 of FIG. 23, the data in databases 105 and external databases 117, to create custom-fit meal plans. For the purposes hereof, “Recipes” may include information pertaining to preparing food at home. This information may include recipe name, list of ingredients, background story about the recipe, serving size, yield, preparation directions, preparation time, cooking time, course, cuisine, occasion, pictures, videos, audios, nutrition facts (total fat, % daily value, etc.) and other tags. For the purposes hereof, “Menu Item” may include information about food away from home, including the menu item name, recipe, price, nutrition facts (total fat, % daily value, etc.), ingredients and other data (endorsements, allergy information, warnings, etc.). It may also include information about the Prepared Food Provider and where the menu item is available including establishment name, address and contact details.

After Meal Plan Decision Procedure is initiated in step 1000, the meal plans are created in step 1001, balanced in step 1006, and then displayed to the Customer in step 1009.

In step 1002, business algorithm 108 assigns a weight value to the data based on the first set of inputs for each recipe, diet choice, menu, food item or nutritional information stored in databases 105 for each Customer. This weight value is numeric or alphanumeric numbers assigned based on the information selected by the Customer in the customer questionnaire 301 and the recipe and meal plan information. The weight values are stored in the databases 105. The first set of inputs may include a designation of a favorite food from the user and the favorite food is assigned a high weight value. Similarly, the first set of inputs includes a designation of a disliked food from the user and the disliked food is assigned a low weight value. For example, all recipes or menu items containing ingredients that the family members dislike or are allergic to may be assigned a lower weight value. In another example, all recipes or menu items that match the dietary preferences of the family indicated in diet preferences 304 may be assigned higher weight values compared to those recipes or menu items that are not included in the Customer dietary preferences.

The weight values may also include calculations. For example, weight value 3 may be derived by multiplying weight value 1 and weight value 2. Also in this step, the data are ranked by weight value and sorted in different orders and sequences. As an example, first weight value 3 may be sorted in ascending order while weight value 2 may be sorted in descending order. In another instance, if the Customer selects a preferred grocery provider in the grocery preferences 306, then business algorithm 108 uses the grocery provider data in databases 105 and/or external data sets 110 and assigns a zero or low weight value to recipes that have ingredients that are not available at the grocery provider.

An optimization algorithm engine based on the data and first set of inputs is run. In step 1003, business algorithm 108 generates a first meal plan for a time period for when the meal plan will be utilized by the user based on the first set of inputs. In one embodiment, the time period for the meal plan is one week. In another embodiment, the time period for the meal plan is one month. The meal plan is displayed to the user on a device.

This is accomplished by assigning recipes and menu items to each day of the calendar by using their weight values calculated in step 1002 and the preferences of the Customer indicated in customer questionnaire 301. The meal plan is stored in databases 105. In one embodiment, the meal plan may be assigned recipes and menu items with weight values over a certain threshold, in descending order of the weight values. In another embodiment, the meal plan may be created by randomly assigning recipes and menu items that have weight values over a certain threshold. In a further embodiment, in meal plan preferences 305, if the Customer chooses to create a meal plan for cooking at home for one week, then a meal plan for one week is created by assigning recipes to each Course for each day of the week. In another embodiment, if the Customer chooses to cook for two days at a time, then the meal plan is created by assigning recipes to every other day. In yet another embodiment, if the Customer chooses to order food away from home for lunch for one of the family members, then the meal plan may be created by assigning menu items for lunch from one of the restaurants near the work place of the family member.

In step 1004, business algorithm 108 creates a Caloric Gap for each Course by applying a factor and decreasing or increasing the ‘Recommended Daily Caloric Intake’ for each Course (from step 203) to arrive at ‘Adjusted-Recommended-Daily-Caloric-Intake’. Recommended-Daily-Caloric-Intake-for-Breakfast=Caloric-Gap-for-Breakfast +Adjusted-Recommended-Daily-Caloric-Intake-for-Breakfast. The purpose of calculating this Caloric Gap is to balance the meals in steps 1006.

In step 1005, business algorithm 108 increases or decrease the serving and portion sizes of the recipes and menu items, by Course, to approximately match the Adjusted-Recommended-Daily-Caloric-Intake by Course as calculated in step 1005. For example, if the Adjusted-Recommended-Daily-Caloric-Intake-for-Breakfast is 1,000 calories, and the recipe is 1,300 calories, then the serving size and quantities of ingredients are lowered to approximately match the 1,000 calories. The meal plan stored in the databases 105 is updated with revised recipe and menu item information.

In step 1007, business algorithm 108 compares the meal plan to ‘Ideal Meal Plan’ (from step 203) and calculates the Deficiencies and Abundances. Deficiencies and Abundances are a list of characteristics that the meal plan has too less of or too much of, respectively. For example, if 20% of the meal plan constitutes vegetables and the ‘Ideal Meal Plan’ recommends that 50% of meal plan be vegetables, then the Deficiency would be 30% vegetables. In another example, if the meal plan consists of 60% dairy and the ‘Ideal Meal Plan’ recommends 20% dairy, then the Abundance is 40% dairy.

In step 1008, business algorithm 108 addresses the Deficiencies and Abundances by increasing or decreasing the serving sizes and portion sizes of the recipes and menu items and/or by adding and removing recipes and menu items from the meal plan. The revised meal plan is stored in account management 107.

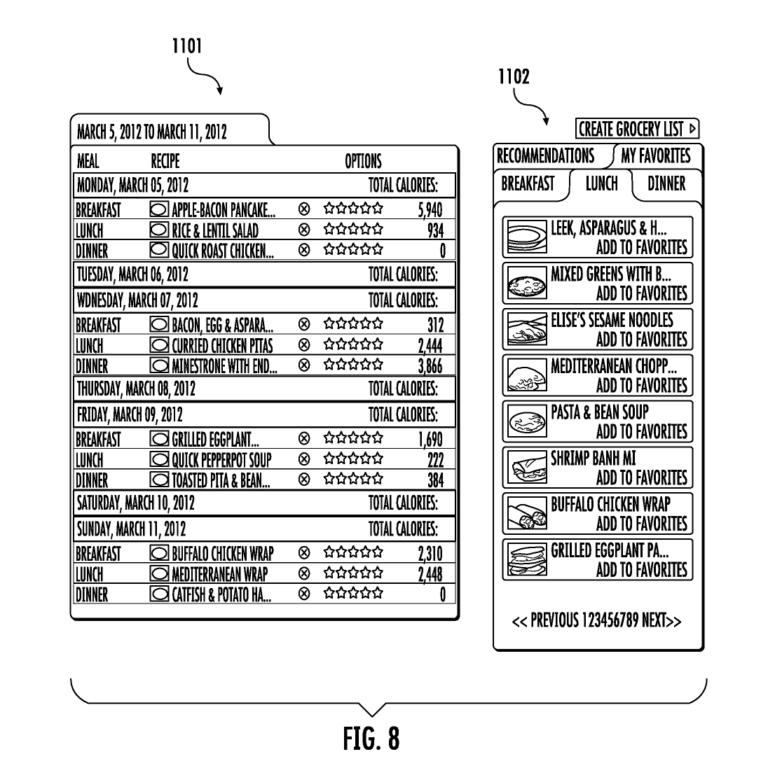

In step 1009, the meal plan along with an ‘Options List’ is displayed. The ‘Options List’ includes recipes and menu items that were not assigned to the meal plan, but match the family profile of the Customer. The weight values of these recipes and menu items may be above the threshold, but for various reasons were not assigned to the meal plan. FIG. 8 is an example embodiment of the meal plan 1101 with the Options List 1102.

As shown in FIG. 7, in step 1010, the Customer is queried if the meal plan is satisfactory. If the Customer is not satisfied, then at step 1011, a second set of inputs are received from the user after the displaying where the second set of inputs are based on the first meal plan. For example, the Customer may edit the meal plan by replacing recipes and menu items in the meal plan from the recipes and menu items in the ‘Options List’. In other embodiments, the Customer may swap recipes and menu items between courses and/or different days of the meal plan. After the edits by the Customer, a second meal plan is generated and displayed to the user on a device. Steps 1000 to 1010 are repeated until the Customer is satisfied with the meal plan and confirmation of acceptance from the Customer or user is received. At step 1010, after receiving the acceptance from the Customer or user, the second meal plan is saved in a memory in step 1012 in account management 107.

Referring to FIG. 6, in step 902, the Customer requests a grocery list for the meal plan saved in the memory in step 1012. In step 903, business algorithm 108 uses the information in the family profile of the Customer and the data in the databases 105 and external data sets 110, to create one or more grocery lists. The grocery list is created by including the ingredients and quantities required to prepare the recipes in the meal plan, by adding the quantities of similar ingredients and by subtracting left over quantities from prior grocery lists. For example, if one recipe includes one cup of tomato paste and another recipe includes two cups of tomato paste, and one cup of tomato paste has been left over from a prior grocery list, then the current grocery list would include the left over one cup of tomato paste. Business algorithm 108 rounds up the quantities in the grocery list to match the quantities the food item is generally sold in. For example, if the recipe requires 12 ounces of kidney beans, then this quantity is rounded up to ‘One 15 ounce can of kidney beans’ as kidney beans are generally sold in a 15 ounce can. The grocery list is saved in account management 107.

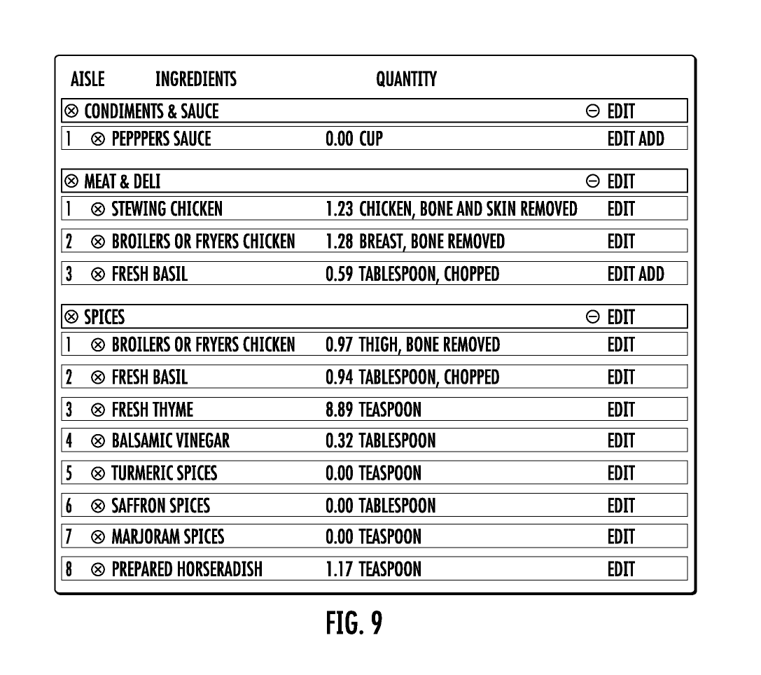

In step 904, the grocery list is displayed. The ingredients are organized under categories such as Dairy, Baking, Meats, and the like. In one embodiment, these categories broadly represent the aisles of Grocery Providers. In another embodiment, if the actual aisle listing of the preferred Grocery Provider of the Customer is available to the meal decision engine 103, the grocery list is displayed using the aisle listing as categories. In another embodiment, items like salt, pepper, sugar, or the like that are generally stocked in the pantries will be separately categorized as “items you might have”. In a further embodiment, if all the items are not available at one Grocery Provider, two or more grocery lists are created. In this step, the Customer, if needed, edits the grocery list(s) by adding, deleting or editing categories, ingredients or quantities. FIG. 9 shows an example embodiment of the Grocery List.

As shown in FIG. 6, in step 905, the grocery list is saved in account management 107. In step 906, the Customer has the option to print, export, email and/or share the meal plan and grocery lists. In step 907, the meal decision engine 103 checks whether the preferred Grocery Provider of the Customer accepts online orders. If the Grocery Provider does not accept online orders, then the Customer is transferred to customer dashboard. If the Grocery Provider accepts online orders, then in step 908, the Customer may request quotes from the Grocery Provider. Business algorithm 108 uses the Grocery Provider data in databases 105, external data sets 110 and grocery preferences 306 to research prices for items on the grocery list, and display the prices.

In step 909, when the Customer selects one or more ‘priced grocery lists’ and chooses to pay, business algorithm 108 uses the payment information from account information 302 and completes the transaction. In step 910, the Customer is transferred to the Grocery Provider website for fulfillment.

As shown in FIG. 3, in step 205, if the Customer chooses to create or edit recipes or diets, then in step 206, the Customer selects between recipes or diets. If the Customer chooses recipes, then recipe publication procedure 1300 is initiated.

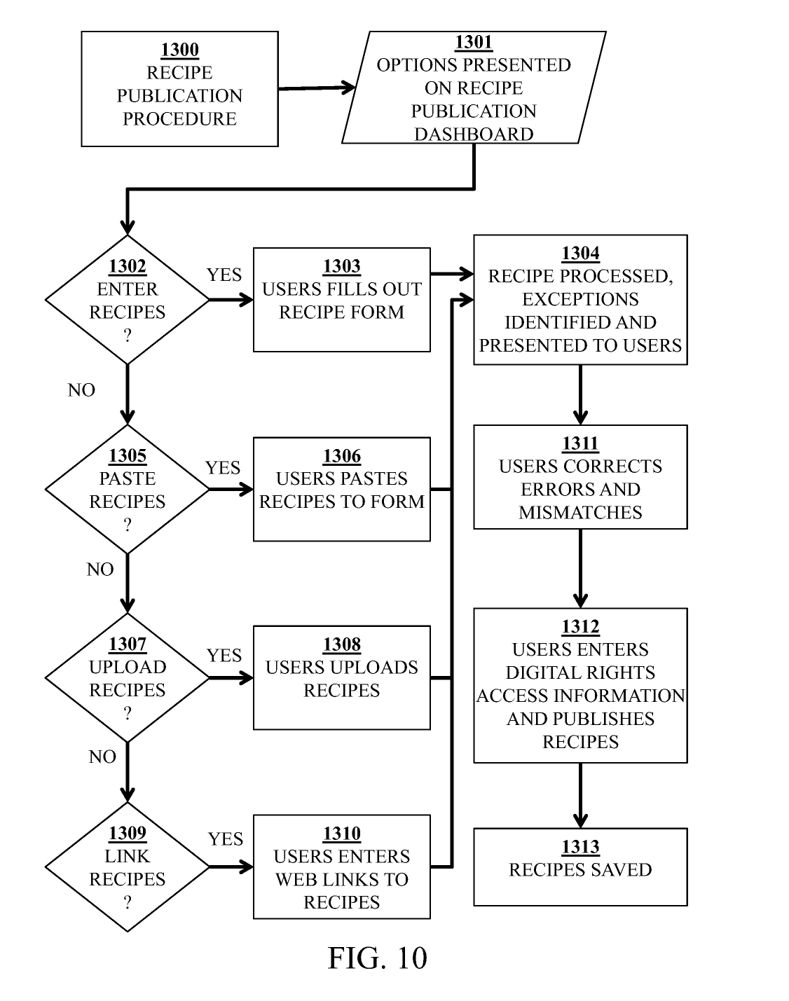

FIG. 10 illustrates an example flowchart for a recipe publication procedure or a method for Users to create, edit and publish recipes. In step 1301, the Users are presented with four options: enter recipes 1302, paste recipes 1305, upload recipes 1307 and link recipes 1309. In step 1302, if the Users choose to enter recipes, then in step 1303, the Users are presented with a recipe form that prompts Users to input the components of a Recipe. In step 1304, business algorithm 108 processes the recipe form and maps the contents to the recipe structure in databases 105. Any components not mapped correctly are returned as errors and presented to the Users. In step 1311, the Users may correct the errors and mismatches. In step 1312, the Users enter the digital rights information. Examples of digital rights information include other Users allowed to access the recipe and whether the recipe is available for free or for a fee. In step 1313, the recipes and digital rights information are stored in databases 105 and digital rights 106, respectively. In this way, the method is a platform for communication, ordering and payment for the user.

In step 1305, if the Users choose to copy the recipe from other sources, then in step 1306, business algorithm 108 presents the Users with a form to paste the recipe. In step 1307, if the Users select to upload the recipe from a device, then in step 1308, business algorithm 108 presents the Users with a form to upload the recipe. In step 1309, if the users choose to provide a link or hyperlink for a recipe, then in step 1310 business algorithm 108 presents the Users with a form to enter the link or hyperlink.

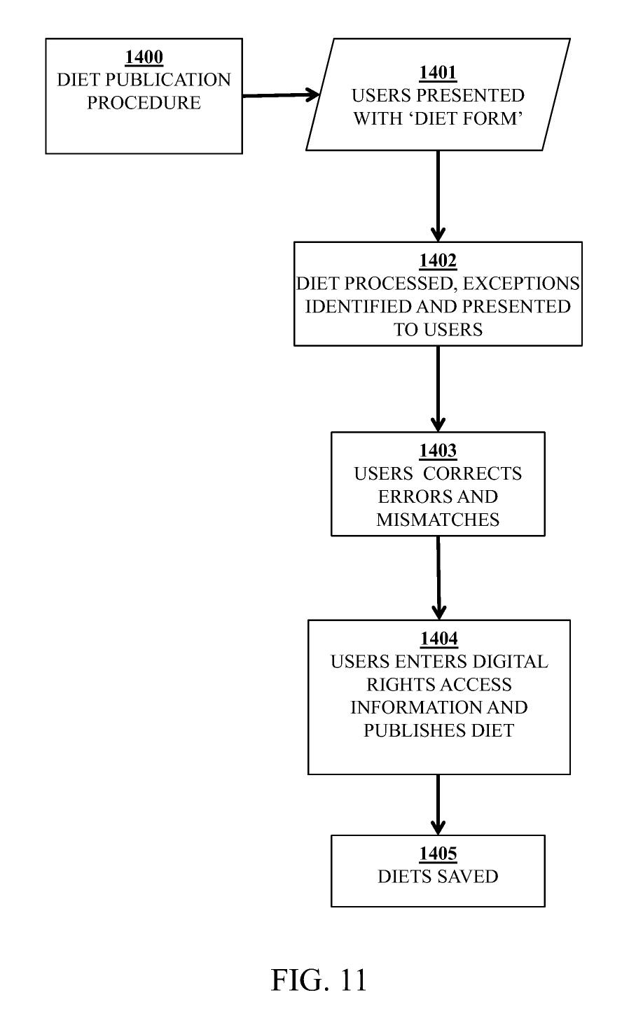

As shown in FIG. 3, in step 206, if the Customer selects diets, then a diet publication procedure 1400 is initiated. FIG. 11 depicts an example flowchart for a diet publication procedure or a method for the Users to create, edit and publish diets. For the purposes hereof, “Diet” may include the name of the diet, author, what to eat, how much to eat, what to avoid, neutral foods and when to eat. As an example, a ‘Watermelon Diet’ may include eating one pound of watermelon on Mondays, one and a half pounds on Thursdays and two pounds on Fridays, and may include avoiding other melons while on this diet. In step 1401, business algorithm 108 presents the Users with a form to enter and upload diets. The diet form prompts the Users to fill out all the components of a diet.

In step 1402, business algorithm 108 processes the diet and maps the contents to the diet structure in databases 105. The components that are not mapped correctly are returned as errors and presented to the Users. In step 1403, the Users correct the errors and mismatches. In step 1404, the Users enter the digital rights information. Examples of digital rights information include other Users allowed to access the recipe and whether the diet free or requires a fee to be paid. In step 1405, the diet and digital rights information are stored in databases 105 and digital rights 106, respectively.

As shown in FIG. 3, in step 207, the Customer is presented with a form to browse or search content including recipes, diets, ingredients, meal plans, grocery lists, reports and other charts and reports. After the Customer inputs the information in the form, business algorithm 108 uses the information submitted by the Customer to search, browse and filter the content from databases 105 and external databases 110, then display the information.

Referring to FIG. 3, in step 208, the Customer is presented with a form on the interface 102 to view reports and archives. For purposes hereof, “Reports” and “Archives” may include information about the Customer profile, Customer activity, meal plans, diets, recipes and all information stored in account management 107. For example, a report may include a chart showing the trends of how the family members are losing weight over time. In another example, an archive may include all the meal plans or grocery lists in the past year. The user may display and modify information in various formats such as graphs, pictures, or tables. This information may include the number of total calories consumed, amount of protein consumed or cost of groceries per day, week, month or another timeframe.

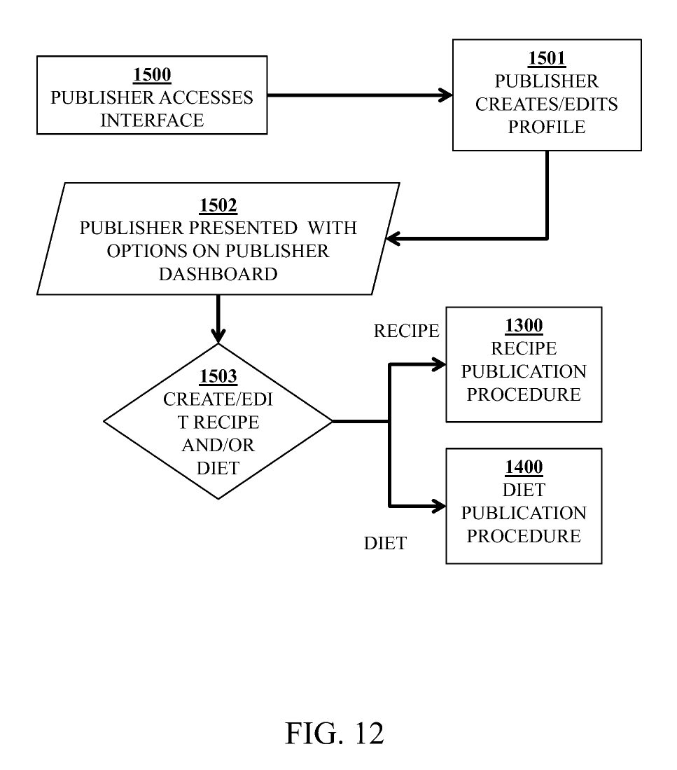

FIG. 12 is an example flowchart for publisher interaction or a method for the Publisher to create, edit and publish recipes and diets and manage accounts. In step 1500, the Publisher accesses MOOBP 100 using interface 102. In step 1501, the Publisher creates or edits a profile including billing information. This profile is saved in account management 107. In step 1502, the Publisher selects between creating and/or editing recipes or diets. If the Publisher chooses recipes, then recipe publication procedure 1300 is initiated. If the Publishers choose diets, then recipe publication procedure 1400 is initiated.

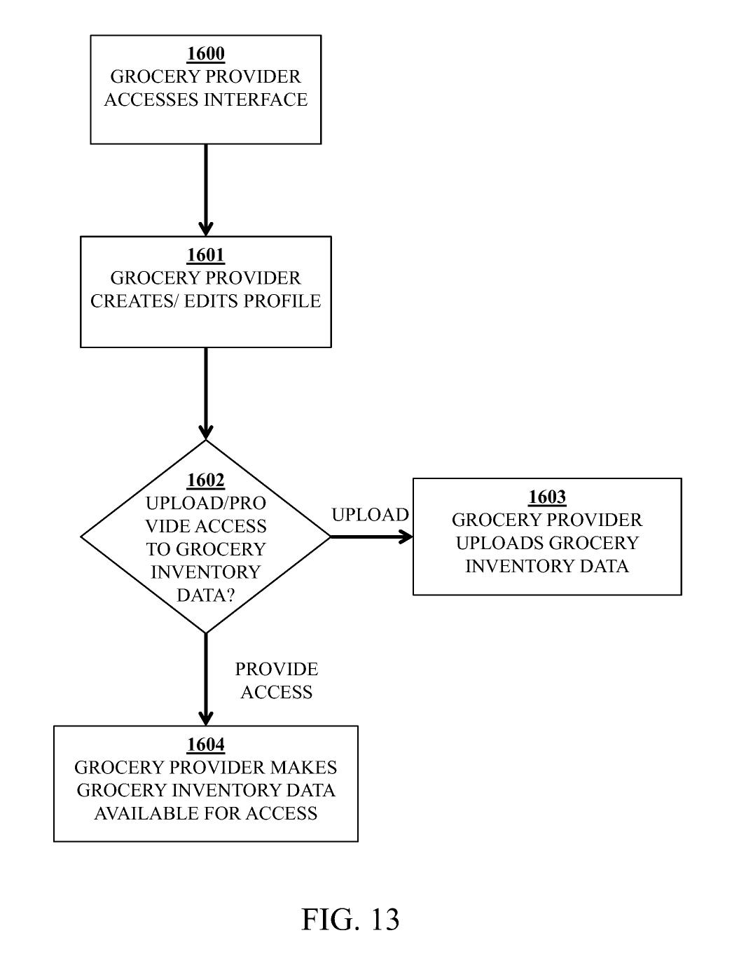

FIG. 13 shows an example flowchart for grocery provider interaction or a method for the Grocery Provider to upload or make available Grocery Inventory Data to the meal decision engine 103. For the purposes hereof, “Grocery Inventory Data” may include information about items sold at a Grocery Provider including item names, Universal Product Codes (UPC), manufacturer name, brand, nutrition facts (total fat, % daily value, etc.), ingredients, shelf management (product dimension, pack size, etc.) and other data (endorsements, allergy information, warnings, etc.). In step 1600, the Grocery Provider accesses MOOBP 100 using interface 102. In step 1601, the Grocery Provider creates or edits a profile including billing information. This profile is saved in account management 107. In step 1602, the Grocery Provider is presented with two options: upload or provide access to grocery inventory data. If the Grocery Provider chooses to upload grocery inventory data, then in step 1603, the Grocery Provider is presented with a form on interface 102 to upload a file containing grocery inventory data. This file is stored in databases 105. In step 1602, if the Grocery Provider chooses to provide access to the grocery inventory data, then in step 1604, the Grocery Provider is presented with a form on interface 102 to provide information that will assist business algorithm 108 to access this data. Business algorithm 108 treats this data as external data sets 110. This information to access the grocery inventory data is stored in the account management 107.

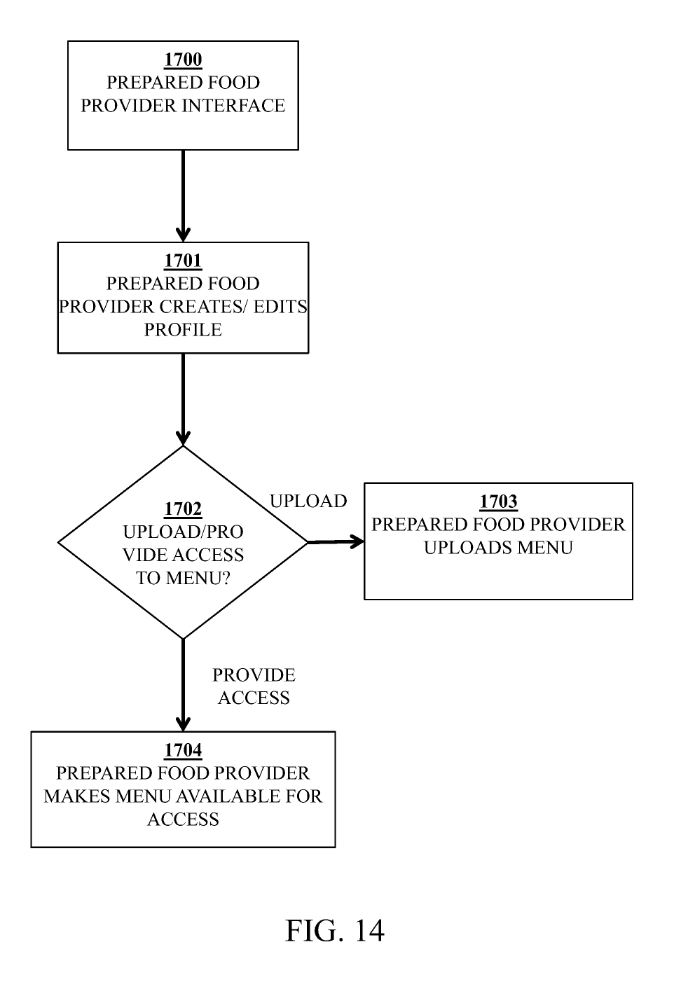

FIG. 14 illustrates an example flowchart for prepared food provider interaction or a method for the Prepared Food Provider to upload or make available a menu for the Prepared Food Provider to the meal decision engine 103. For the purposes hereof, “Menu” include a collection of menu items. In step 1700, the Prepared Food Provider accesses MOOBP 100 using interface 102. In step 1701, the Prepared Food Provider creates or edits the profile including billing information. This profile is saved in account management 107. In step 1702, the Prepared Food Provider is presented with two options: upload or provide access to menu. If the Prepared Food Provider chooses to upload menu, then in step 1703, the Prepared Food Provider is presented with a form on interface 102 to upload a file containing the menu. This file is stored in databases 105. In step 1702, if the Prepared Food Provider chooses to provide access to the menu, then in step 1704, the Prepared Food Provider is presented with a form on interface 102 to provide information that will assist business algorithm 108 to access this data. Business algorithm 108 treats this data as external data sets 110. This information to access the menu is stored in account management 107.

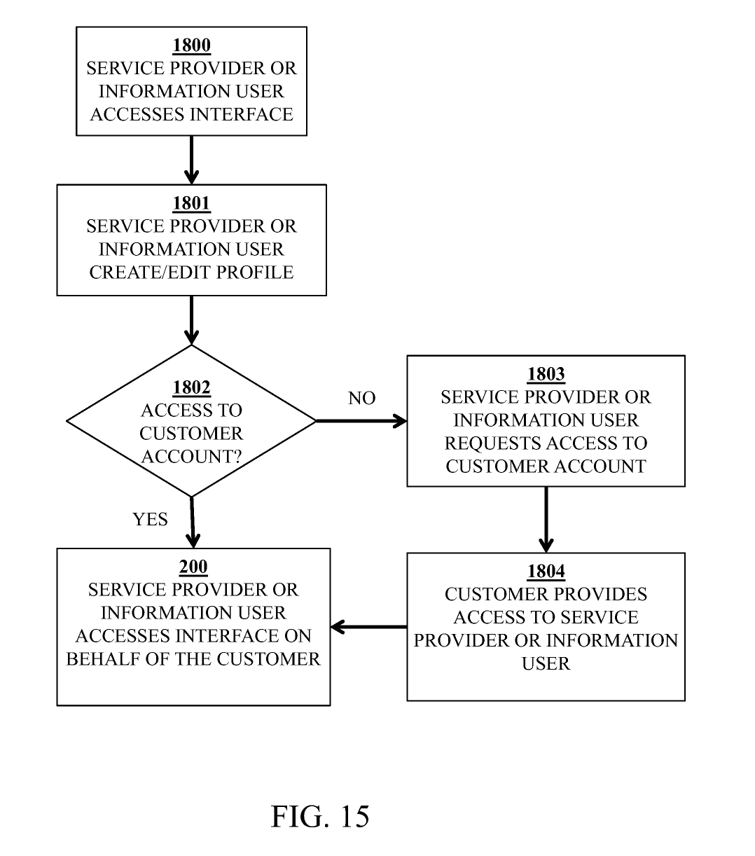

FIG. 15 shows an example flowchart for the service provider or information user interaction. This flowchart depicts the Service Provider or the Information User accessing a customer interface 200 and creating meal plans, grocery lists, recipes and diets on behalf of the Customer. The Customer information is accessed and stored in account management 107. In step 1800, the Service Provider or the Information User accesses MOOBP 100 using interface 102. In step 1801, the Service Provider or the Information User creates or edits a profile including billing information. This profile is saved in account management 107. In step 1802, business algorithm 108 checks digital rights 106 for the Service Provider and the Information User and account management 107 to ensure the Service Provider and Information User has access to the account of the Customer. If the Service Provider or the Information User does not have access to the account of the Customer, then in step 1803 the Service Provider or the Information User requests access to the account of the Customer. In step 1804, the Customer provides the Service Provider or the Information User access to the account and this permission is saved in account management 107 and digital rights 106. The Service Provider or the Information User moves to step 200 with complete access to the account of the Customer. Referring back to step 1802, if the Service Provider or the Information User already has access to the account of the Customer, then the Service Provider or the Information User moves to step 200.

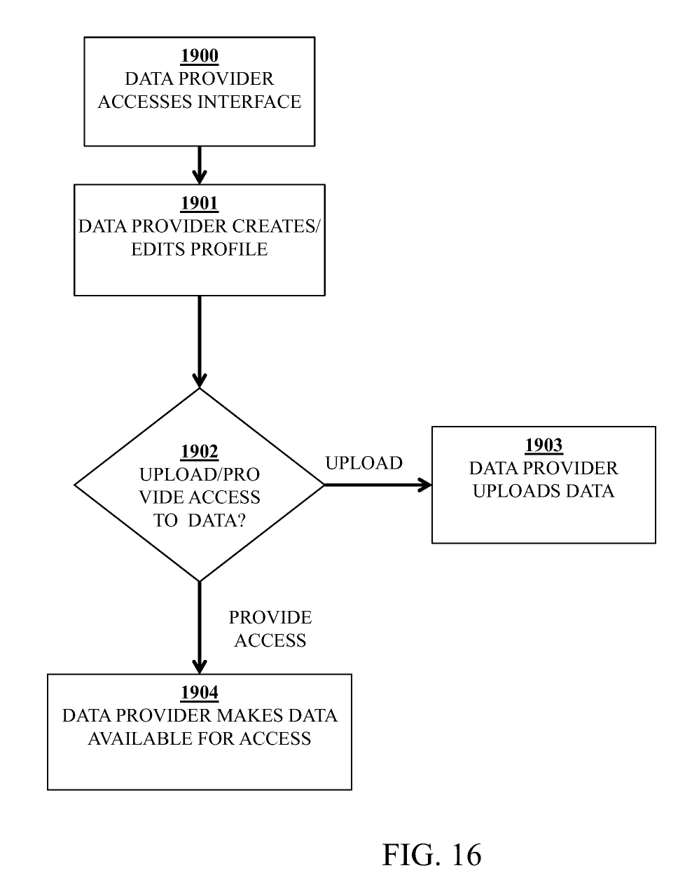

FIG. 16 is an example flowchart for data provider interaction or a method for the Data Provider to upload or make available data to the meal decision engine 103. For the purposes hereof, “Data” may include any kind of information. In step 1900, the Data Provider accesses MOOBP 100 using interface 102. In step 1901, the Data Provider creates or edits a profile including billing information. This profile is saved in account management 107. In step 1902, the Data Provider is presented with two options: upload or provide access to data. If the Data Provider chooses to upload data, then in step 1903, the Data Provider is presented with a form on interface 102 to upload a file containing data. This file is stored in databases 105. In step 1902, if the Data Provider chooses to provide access to the data, then in step 1904, the Data Provider is presented with a form on interface 102 to provide information that will assist business algorithm 108 to access this data. Business algorithm 108 treats this data as external data sets 110. This information to access the data is stored in the account management 107.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those of ordinary skill in the art, without departing from the spirit and scope of the present invention. Furthermore, those of ordinary skill in the art will appreciate that the foregoing description is by way of example only, and is not intended to limit the invention. Thus, it is intended that the present subject matter covers such modifications and variations.

What is claimed:

1. A method for meal optimization comprising:
i) populating a database with data, the data in the database include recipes, diet choices, menus, food items or nutritional information;
ii) receiving a first set of inputs from a user, the first set of inputs being received from a device used by the user, the first set of inputs being associated with the data in the database;
iii) assigning a weight value to the data based on the first set of inputs;
iv) ranking the data by the weight value;
v) running an optimization algorithm engine based on the data and first set of inputs;
vi) generating a first meal plan;
vii) displaying the first meal plan to the user on the device;
viii) receiving a second set of inputs from the user after the displaying, the second set of inputs being based on the first meal plan;
ix) generating a second meal plan;
x) displaying the second meal plan to the user on the device;
xi) receiving confirmation of acceptance from the user; and
xi) after receiving the confirmation from the user, saving the second meal plan in a memory;
wherein the method is performed by a software program.

2. The method of claim 1, wherein the device is a computer, laptop, tablet or smartphone.

3. The method of claim 1, further comprising, before displaying the first meal plan, saving the first meal plan in the memory.

4. The method of claim 1, wherein the first set of inputs includes a time period for when the meal plan will be utilized by the user.

5. The method of claim 4, wherein the time period for the meal plan is one week.

6. The method of claim 1, further comprising, before displaying the first meal plan, saving the first meal plan in the memory.

7. The method of claim 1, wherein the first set of inputs includes a designation of a favorite food from the user, the favorite food being assigned a high weight value.

8. The method of claim 1, wherein the first set of inputs includes a designation of a disliked food from the user, the disliked food being assigned a low weight value.

9. The method of claim 1, wherein the first set of inputs includes the option to exclude food items.

10. The method of claim 1, further comprising a platform for communication, ordering and payment for the user.

11. The method of claim 1, wherein the user includes a customer, publisher, grocery provider, prepared food provider, service provider, information user and data provider.

12. A machine-readable medium including instructions executable by the machine for meal optimization, the instructions causing the machine to:
i) populate a database with data, the data in the database include recipes, diet choices, menus, food items or nutritional information;
ii) receive a first set of inputs from a user, the first set of inputs being received from a device used by the user, the first set of inputs being associated with the data in the database;
iii) assign a weight value to the data based on the first set of inputs;
iv) rank the data by the weight value;
v) run an optimization algorithm engine based on the data and first set of inputs;
vi) generate a first meal plan;
vii) display the first meal plan to the user on the device;
viii) receive confirmation of acceptance from the user; and
ix) after receiving the confirmation from the user, saving the first meal plan in a memory;
wherein the machine-readable medium is performed by a software program.

13. The machine-readable medium of claim 12, wherein the device is a computer, laptop, tablet or smartphone.

14. The machine-readable medium of claim 12, wherein the first set of inputs includes a time period for when the meal plan will be utilized by the user.

15. The machine-readable medium of claim 14, wherein the time period for the meal plan is one week.

16. The machine-readable medium of claim 12, wherein the first set of inputs includes a recipe from the user.

17. The machine-readable medium of claim 12, wherein the first set of inputs includes a designation of a favorite food from the user, the favorite food being assigned a high weight value.

18. The machine-readable medium of claim 12, wherein the first set of inputs includes the option to exclude food items.

19. The machine-readable medium of claim 12, further comprising a platform for communication, ordering and payment for the user.

20. The machine-readable medium of claim 12, further comprising:
i) receiving a second set of inputs from the user after the displaying, the second set of inputs being based on the first meal plan;
ii) generating a second meal plan; and
iii) displaying the second meal plan to the user on the device.
